(19) United States
(12) Patent Application Publication
(10) Pub. No.: US 2024/0343534 A1
(43) Pub. Date: Oct. 17, 2024

(54) VEHICLE LIFTING DEVICE

(71) Applicant: Monique AuMiller, Waterford, MI (US)

(72) Inventor: Monique AuMiller, Waterford, MI (US)

(21) Appl. No.: 18/133,025

(22) Filed: Apr. 11, 2023

(51) Int. Cl. B66F 3/40

(52) U.S. Cl. CPC B66F 3/40

(57) ABSTRACT

A vehicle lifting device, including a main body, including a first section removably disposed on at least a portion of a motor vehicle to elevate the motor vehicle to a first predetermined angle in response to inflating the first section, a second section disposed on at least a portion of the first section to elevate the motor vehicle to a second predetermined angle in response to inflating the second section, a third section disposed on at least a portion of the second section to elevate the motor vehicle to a third predetermined angle in response to inflating the third section, and a fourth section disposed on at least a portion of the third section to elevate the motor vehicle to a fourth predetermined angle in response to inflating the fourth section, an air inflation unit disposed on at least a portion of at least one of the first section, the second section, the third section, and the fourth section to inflate at least one of the first section, the second section, the third section, and the fourth section, and a plurality of adjustable straps disposed on at least a portion of the first section to removably connect the first section, the second section, the third section, and the fourth section to the motor vehicle.

### BACKGROUND

### 1. Field

The present general inventive concept relates generally to vehicles, and particularly, to a vehicle lifting device.

### 2. Description of the Related Art

A motorcycle is a two-wheeled or three-wheeled motor vehicle. Motorcycles come in a wide variety of shapes and sizes depending on usage, such as long-distance travel, racing, and/or off-road riding. Motorcycles are prone to falling over, especially the two-wheeled variants.

However, motorcycles are often heavy and difficult for a user to lift alone after having fallen to the ground. Moreover, lifting the motorcycle by a user with a disability and/or someone with a smaller stature are likely unable to do so.

Therefore, there is a need for a vehicle lifting device that can be easily carried on the motorcycle and assists in lifting the motorcycle after it has fallen.

### SUMMARY

The present general inventive concept provides a vehicle lifting device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a vehicle lifting device, including a main body, including a first section removably disposed on at least a portion of a motor vehicle to elevate the motor vehicle to a first predetermined angle in response to inflating the first section, a second section disposed on at least a portion of the first section to elevate the motor vehicle to a second predetermined angle in response to inflating the second section, a third section disposed on at least a portion of the second section to elevate the motor vehicle to a third predetermined angle in response to inflating the third section, and a fourth section disposed on at least a portion of the third section to elevate the motor vehicle to a fourth predetermined angle in response to inflating the fourth section, an air inflation unit disposed on at least a portion of at least one of the first section, the second section, the third section, and the fourth section to inflate at least one of the first section, the second section, the third section, and the fourth section, and a plurality of adjustable straps disposed on at least a portion of the first section to removably connect the first section, the second section, the third section, and the fourth section to the motor vehicle.

The air inflation unit may inflate the first section, the second section, the third section, and the fourth section independently with respect to each other.

The air inflation unit may inflate the first section, the second section, the third section, and the fourth section simultaneously.

The air inflation unit may use at least one chemical to inflate at least one of the first section, the second section, the third section, and the fourth section.

The air inflation unit may automatically inflate at least one of the first section, the second section, the third section, and the fourth section after detecting the motor vehicle disposed on at least one of the first section, the second section, the third section, and the fourth section for a predetermined period of time.

The vehicle lifting device may further include a plurality of fasteners disposed on at least a portion of the plurality of adjustable straps to removably connect the plurality of adjustable straps to the motor vehicle.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of a vehicle lifting device, according to an exemplary embodiment of the present general inventive concept;

FIG. 2 illustrates an elevational top view of the vehicle lifting device, according to an exemplary embodiment of the present general inventive concept;

FIG. 3A illustrates a side perspective view of the vehicle lifting device in a first position, according to an exemplary embodiment of the present general inventive concept; and

FIG. 3B illustrates a side perspective view of the vehicle lifting device in a second position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Vehicle Lifting Device 100
Main Body 110
First Section 111
Second Section 112
Third Section 113
Fourth Section 114
Air Inflation Unit 120
Control Unit 130
Power Source 140
Adjustable Straps 150
Fasteners 160

FIG. 1 illustrates a front perspective view of a vehicle lifting device 100, according to an exemplary embodiment of the present general inventive concept.

The vehicle lifting device 100 may be constructed from at least one of metal, plastic, cloth, and rubber, etc., but is not limited thereto.

The vehicle lifting device 100 may include a main body 110, an air inflation unit 120, a control unit 130, a power source 140, a plurality of adjustable straps 150, and a plurality of fasteners 160, but is not limited thereto.

The main body 110 may be constructed of silicone aramid fiber, but is not limited thereto. In other words, the main body 110 may be highly durable and withstand heavy pressures and/or weight disposed thereon due to high tensile strength.

The main body 110 may include a first section 111, a second section 112, a third section 113, and a fourth section 114, but is not limited thereto.

Collectively, the first section 111, the second section 112, the third section 113, and/or the fourth section 114 may form an inflatable bladder. However, the first section 111, the second section 112, the third section 113, and/or the fourth section 114 may inflate independently with respect to each other. Alternatively, the first section 111, the second section 112, the third section 113, and/or the fourth section 114 may inflate simultaneously. The first section 111, the second section 112, the third section 113, and/or the fourth section 114 may each be equivalent in size (e.g., length, width, etc.).

The first section 111 may be removably disposed on at least a portion of a motor vehicle 10, such as a motorcycle, a car, a truck, a bus, etc. The second section 112 may be disposed on at least a portion of the first section 111. The third section 113 may be disposed on at least a portion of the second section 112. Lastly, the fourth section 114 may be disposed on at least a portion of the third section 113.

The first section 111, the second section 112, the third section 113, and/or the fourth section 114 may increase in volume level in response to inflating and/or being inflated.

The air inflation unit 120 may include a pump, a motor, an igniter, and a switch, but is not limited thereto.

The air inflation unit 120 may be disposed on at least a portion of the first section 111, the second section 112, the third section 113, and/or the fourth section 114. The air inflation unit 120 may blow air into the first section 111, the second section 112, the third section 113, and/or the fourth section 114 in response to being turned on. More specifically, the pump may dispense air into the first section 111, the second section 112, the third section 113, and/or the fourth section 114 after being turned on using the switch a first time. Conversely, the air inflation unit 120 may turn off in response to using the switch a second time.

Also, the air inflation unit 120 may inflate the first section 111, the second section 112, the third section 113, and/or the fourth section 114 independently based on depressing the switch for a predetermined period of time (e.g., two seconds for the first section 111, five seconds for the second section 112, seven seconds for the third section 113, ten seconds for the fourth section 114). Alternatively, the air inflation unit 120 may inflate the first section 111, the second section 112, the third section 113, and/or the fourth section 114 simultaneously in response to depressing the switch rapidly in succession (e.g., two times, three times).

Furthermore, the air inflation unit 120 may use chemicals to cause inflation of the main body 110. For example, the air inflation unit 120 may use guanidinium nitrate, sodium azide, and copper nitrate oxidizer to generate nitrogen gas in response to being ignited. However, other chemicals may be used to cause inflation.

The control unit 130 may include a processing unit and a sensor, but is not limited thereto.

The processing unit of the control unit 130 may be a computer. Moreover, the processing unit of the control unit 130 may include a processing unit (or central processing unit, CPU) including electronic circuitry to carry out instructions of a computer program by performing basic arithmetic, logical, control and input/output (I/O) operations specified by the instructions. The processing unit of the control unit 130 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 130 may also include a microprocessor and a microcontroller.

Also, the sensor of the control unit 130 may include a weight sensor, but is not limited thereto.

The control unit 130 may be disposed within at least a portion of the first section 111, the second section 112, the third section 113, and/or the fourth section 114. The control unit 130 may be connected to the air inflation unit 120. The control unit 130 may monitor and/or control the air inflation unit 120. For example, the control unit 130 may control the air inflation unit 120 to inflate the first section 111, the second section 112, the third section 113, and/or the fourth section 114 independently, and/or simultaneously based on current needs and/or a preference of a user. As such, the first section 111 may inflate first, followed by the second section 112, followed by the third section 113 and/or the fourth section 114.

Also, the control unit 130 may automatically inflate the first section 111, the second section 112, the third section 113, and/or the fourth section 114 after detecting a predetermined weight disposed on the first section 111, the second section 112, the third section 113, and/or the fourth section 114 for a predetermined period of time (e.g., thirty seconds, one minute).

The power source 140 may include a power inlet, a battery, and a solar cell, but is not limited thereto.

The power source 140 may be disposed within at least a portion of the main body 110 (i.e., the first section 111, the second section 112, the third section 113, and/or the fourth section 114). The power source 140 may provide power to the air inflation unit 120 and/or the control unit 130. Also, the power source 140 may charge the battery in response to the solar cell receive an external light source thereon and/or from the power inlet connected to a power outlet.

The plurality of adjustable straps 150 may be constructed of silicone aramid fiber.

The plurality of adjustable straps 150 may be movably (i.e., slidably) disposed on at least a portion of the main body 110 (i.e., the first section 111, the second section 112, the third section 113, and/or the fourth section 114). Each of the plurality of adjustable straps 150 may move (i.e., slide) from retracted on the main body 110 in a first position to at least partially extended in a second position. Conversely, each of the plurality of adjustable straps 150 may move (i.e., slide) from extended in the second position to retracted on the main body 110 in the first position.

Alternatively, each of the plurality of adjustable straps 150 may be elastic. In other words, each of the plurality of adjustable straps 150 may at least partially deform (e.g., bend, stretch, expand) in response to an application of force (e.g., pushing, pulling) thereto. As such, the plurality of adjustable straps 150 may be stretched to different lengths (e.g., increased in length) based on needs of the user. The plurality of adjustable straps 150 may removably (i.e., detachably) connect the main body 110 to the motor vehicle 10. Moreover, the plurality of adjustable straps 150 may prevent the main body 110 from moving away from the motor vehicle 10 while connected to the motor vehicle 10. In other words, the plurality of adjustable straps 150 may stabilize the main body 110 on the motor vehicle 10.

Each of the plurality of fasteners 160 may include a hook, a clamp, a clasp, a clip, an adhesive (e.g., tape, glue), a magnet, and/or any combination thereof, but is not limited thereto.

Each of the plurality of fasteners 160 may be disposed on at least a portion of at least one of the plurality of adjustable straps 150. Specifically, at least one of the plurality of fasteners 160 may be disposed at an end of each of the plurality of adjustable straps 150. Accordingly, the plurality of fasteners 160 may removably connect (i.e., fasten) the plurality of adjustable straps 150 to the motor vehicle 10.

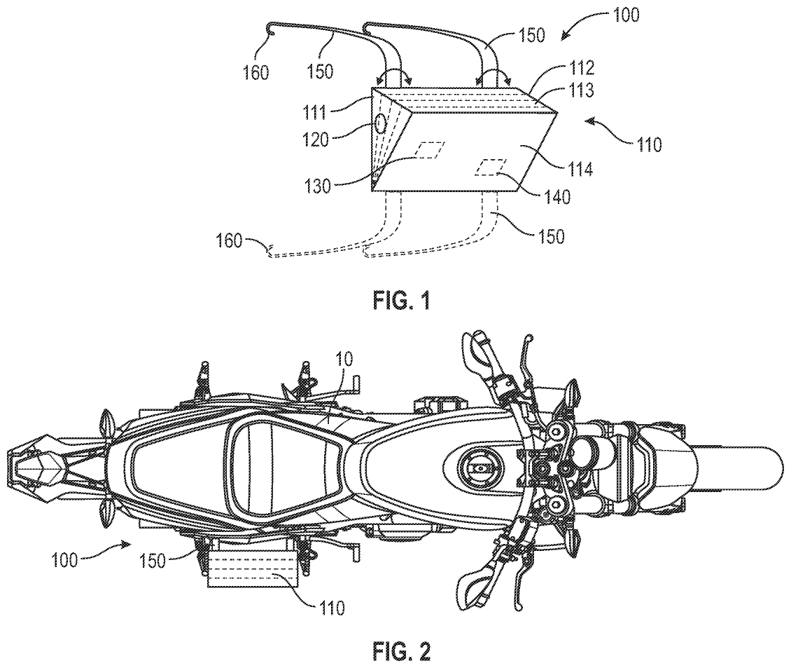

FIG. 2 illustrates an elevational top view of the vehicle lifting device 100, according to an exemplary embodiment of the present general inventive concept.

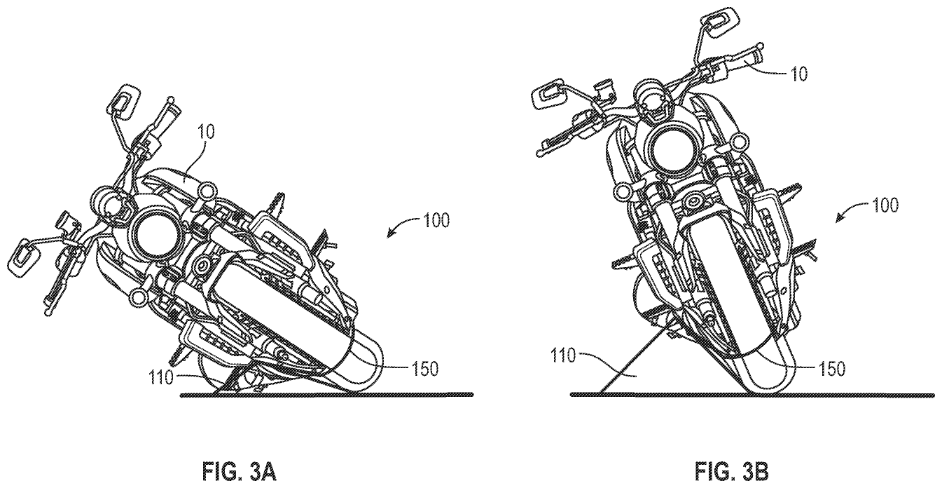

FIG. 3A illustrates a side perspective view of the vehicle lifting device 100 in a first position, according to an exemplary embodiment of the present general inventive concept.

FIG. 3B illustrates a side perspective view of the vehicle lifting device 100 in a second position, according to an exemplary embodiment of the present general inventive concept.

During use, referring to FIGS. 2 through 3B, the main body 110 may be disposed against the motor vehicle 10 that has fallen on a ground surface. The air inflation unit 120 may be activated to inflate the first section 111, the second section 112, the third section 113, and/or the fourth section 114. Moreover, the first section 111, the second section 112, the third section 113, and/or the fourth section 114 may be inflated independently, and/or in stages (e.g., a first stage, a second stage, a third stage, a fourth stage corresponding to the first section 111, the second section 112, the third section 113, and/or the fourth section 114, respectively) based on the preference of the user. As such, the main body 110 may elevate the motor vehicle 10 to facilitate lifting of the motor vehicle 10 by the user.

Furthermore, the control unit 130 may be used to elevate the motor vehicle 10 to at least one predetermined angle (e.g., ten degrees, twenty-five degrees, forty-five degrees, sixty degrees, etc.). Also, the main body 110 may be applied to other items, such as heavy equipment, logging items, and/or people.

Therefore, the vehicle lifting device 100 may safely assist the user in lifting the motor vehicle 10 that has fallen on the ground without risk of injury to the user. Also, the vehicle lifting device 100 may be portable and easily carried in the motor vehicle 10, such as a saddlebag and/or an emergency kit.

The present general inventive concept may include a vehicle lifting device 100, including a main body 110, including a first section 111 removably disposed on at least a portion of a motor vehicle 10 to elevate the motor vehicle 10 to a first predetermined angle in response to inflating the first section 111, a second section 112 disposed on at least a portion of the first section 111 to elevate the motor vehicle 10 to a second predetermined angle in response to inflating the second section 112, a third section 113 disposed on at least a portion of the second section 112 to elevate the motor vehicle 10 to a third predetermined angle in response to inflating the third section 113, and a fourth section 114 disposed on at least a portion of the third section 113 to elevate the motor vehicle 10 to a fourth predetermined angle in response to inflating the fourth section 114, an air inflation unit 120 disposed on at least a portion of at least one of the first section 111, the second section 112, the third section 113, and the fourth section 114 to inflate at least one of the first section 111, the second section 112, the third section 113, and the fourth section 114, and a plurality of adjustable straps 150 disposed on at least a portion of the first section 111 to removably connect the first section 111, the second section 112, the third section 113, and the fourth section 114 to the motor vehicle 10.

The air inflation unit 120 may inflate the first section 111, the second section 112, the third section 113, and the fourth section 114 independently with respect to each other.

The air inflation unit 120 may inflate the first section 111, the second section 112, the third section 113, and the fourth section 114 simultaneously.

The air inflation unit 120 may use at least one chemical to inflate at least one of the first section 111, the second section 112, the third section 113, and the fourth section 114.

The air inflation unit 120 may automatically inflate at least one of the first section 111, the second section 112, the third section 113, and the fourth section 114 after detecting the motor vehicle 10 disposed on at least one of the first section 111, the second section 112, the third section 113, and the fourth section 114 for a predetermined period of time.

The vehicle lifting device 100 may further include a plurality of fasteners 160 disposed on at least a portion of the plurality of adjustable straps 150 to removably connect the plurality of adjustable straps 150 to the motor vehicle 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A vehicle lifting device, comprising:
a main body, comprising:
a first section removably disposed on at least a portion of a motor vehicle to elevate the motor vehicle to a first predetermined angle in response to inflating the first section,
a second section disposed on at least a portion of the first section to elevate the motor vehicle to a second predetermined angle in response to inflating the second section,
a third section disposed on at least a portion of the second section to elevate the motor vehicle to a third predetermined angle in response to inflating the third section, and
a fourth section disposed on at least a portion of the third section to elevate the motor vehicle to a fourth predetermined angle in response to inflating the fourth section;
an air inflation unit disposed on at least a portion of at least one of the first section, the second section, the third section, and the fourth section to inflate at least one of the first section, the second section, the third section, and the fourth section; and
a plurality of adjustable straps disposed on at least a portion of the first section to removably connect the first section, the second section, the third section, and the fourth section to the motor vehicle.

2. The vehicle lifting device of claim 1, wherein the air inflation unit inflates the first section, the second section, the third section, and the fourth section independently with respect to each other.

3. The vehicle lifting device of claim 1, wherein the air inflation unit inflates the first section, the second section, the third section, and the fourth section simultaneously.

4. The vehicle lifting device of claim 1, wherein the air inflation unit uses at least one chemical to inflate at least one of the first section, the second section, the third section, and the fourth section.

5. The vehicle lifting device of claim 1, wherein the air inflation unit automatically inflates at least one of the first section, the second section, the third section, and the fourth section after detecting the motor vehicle disposed on at least one of the first section, the second section, the third section, and the fourth section for a predetermined period of time.

6. The vehicle lifting device of claim 1, further comprising:
a plurality of fasteners disposed on at least a portion of the plurality of adjustable straps to removably connect the plurality of adjustable straps to the motor vehicle.
